(19) United States
(12) Patent Application Publication
(10) Pub. No.: US 2006/0218060 A1
(43) Pub. Date: Sep. 28, 2006

(54) Accounting method and system

(76) Inventor: Erin P. Lawlor, Orem, UT (US)

Correspondence Address: Michael W. Starkweather, Suite 200, 9035 South 1300East, Sandy, UT, 84094, US

(21) Appl. No.: 11/076,504

(22) Filed: Mar. 9, 2005

(51) Int. Cl. G07C 1/10

(52) U.S. Cl. 705/32

(57) ABSTRACT

There is an accounting system, having an item module configured to manage a collection of items; and an event module linked to the item module and configured to describe and manage financial events of an entity. Further, there is a general ledger module configured to provide a master management structure for the item module and event module. There is a set of accounts included in the general ledger module and configured to fit within standard accounting categories; and/or an account definitions module included in the general ledger and configured to assign transactions to individual accounts within the set of accounts according to a determined rule set. Information is configurably interlinked for investigative user exploration.

### BACKGROUND OF THE INVENTION

1. Field of the Invention

The present invention relates to an accounting method and system. Specifically, the present invention relates to an item and event based accounting method and system in which items, associates and events are interconnected to allow access to current and complete data on demand.

2. Description of the Related Art

In conventional accounting methods, data is entered into the system by assigning transactions to accounts on the general ledger and accompanying the transactions with descriptive data. The accounts function as gathering locations for data into reports, both summaries and itemizations, important to understanding the state of a business. Entering transactions accurately and consistently into the right accounts with the right accompanying data is vital to proper accounting.

However, because of the sheer volume of transaction in a typical business and the tedious nature of data entry it is difficult and prohibitively expensive to have certified accountants performing data entry. Therefore, data entry is done by the least qualified accounting personnel, and typically the work treated as manual labor. This makes data entry prone to error, in assigning proper accounts to transactions as well as completeness in the data entry.

Incomplete data entry is not only caused by errors by data entry personnel, but also comes from systematic errors. Financial transactions involve combinations of items and events. Items either act through, or are acted upon events. However, current models do not fully appreciate these properties of financial transactions. Because the current accounting model categorizes transactions based on general ledger account numbers, it either collects data about a type of item or an event, not both. Even in cost accounting, where information is selected about both the item and the event, the treatment of the data is not consistent. Collecting incomplete information results in financial reports based on incomplete and often unverifiable information which results in an inability to effectively manage and safeguard the entity.

Further, an enterprise may find itself in need of additional data detail and more powerful database management needs for a particular account than that provided by the general ledger currently used. In such a case, the business may find a need to acquire a separate accounting module, such as accounts receivable or payroll module, specifically adapted for their current needs for that particular account. Rarely will the new accounting module be configured to interface with the general ledger already in use. The business may either spend a substantial sum for “middle-ware” software designed to bridge the two modules, or to operate each module independently. Typically, this results in doubling the number of database entries for that particular module, thereby increasing chance for error and cost of operation.

Also, because the accounting modules are designed to specifically meet certain needs of a business within a particular account, the modules are crafted to channel the data into predetermined tables and accounts. This typically results in meeting the current needs of the business since the module was designed to accommodate those known needs, but will often fail to properly adapt to changes in the business. Since the data flows through hard coded channels, future unknown database management needs may be difficult and expensive to implement.

Still further, since different details are requested and stored by the general ledger module and the specific account module, the data from one module is not directly accessible from the other. A problem discovered in the general ledger may require exploration in the specific account module to find resolution. Or, the required data may only be useful when compared as a whole across the diverse modules. Or, even worse, the data may be only present within a descriptor field, or not present at all, perhaps because the particular account does not have a separate specialized account module.

While the rules for accounting and assigning transactions to accounts have evolved over time and, with the advent of the computer, the ability to store and retrieve large amounts of data has significantly benefited accounting practice, the guiding principles of the conventional system still copy the principles established during the paper and pencil days of accounting when storage space was limited and data was only descriptive. Therefore some of the fundamental restrictions present during the creation of conventional accounting methods no longer apply. For example, in the pen and paper world, data could only be descriptive. However, with computer systems, data may also be functional. Still, because conventional accounting methods are still founded on the restrictions of the pen and paper world, those methods are artificially and unnecessarily restricted. Businesses using these methods are likewise crippled.

Because the conventional method has widespread acceptance and is inextricably intertwined with our methods of doing business, the unnecessary limitations do widespread systematic harm to businesses. For example, limitations placed on data retrieval and organization by the conventional system make it very difficult to uncover fraud. Billions of dollars are lost by businesses to fraud every year and those losses are largely ignored because the fraud is too expensive to discover and analyze. While recent events have prompted legislation intended to mandate more accountability, the structure of the conventional system impedes those with a duty to obey the new laws. The increased risk to the CEO and CFO, because they are now personally liable for the accuracy of financial statements over which they have little or no actual control, is a serious problem.

What is needed is an accounting method and system having a structure designed to give enhanced access and control of accounting data to management while still following the highly evolved and evolving standards of conventional accounting.

### BRIEF SUMMARY OF THE INVENTION

The present invention has been developed in response to the present state of the art, and in particular, in response to the problems and needs in the art that have not yet been fully solved by currently available accounting systems and methods. Accordingly, the present invention has been developed to provide a system and method of accounting that overcomes many or all of the above-discussed shortcomings in the art.

In one embodiment there is an accounting system, that may include an item module configured to manage a collection of items; and an event module linked to the item module and configured to describe and manage financial events of an entity.

Further, there may be a general ledger module configured to provide a master management structure for the item module and event module. Still further, there may be a set of accounts included in the general ledger module and configured to fit within standard accounting categories; and/or an account definitions module included in the general ledger and configured to assign transactions to individual accounts within the set of accounts according to a determined rule set.

Also, there may be a plurality of item collections defined in the accounting system and configured to organize types of items; an item table for and corresponding to each item collection included in the item module and configured to describe and maintain a record for each individual member of the corresponding item collection; and/or an item/event summary table for and corresponding to each item table included in the item module and configured to summarize values and interactions between items and between items and events.

Additionally, there may be an event table included in the event module and configured to facilitate transaction posting; an event summary table included in the event module and configured to summarize the values of each event/item record from the event table; and/or an event transactions table included in the event module and configured to contain a record for each transaction.

More, there may be an associate module restrictably linked to a module selected from the group consisting of general ledger module, item module, and event module, wherein the associate module may be configured to manage a collection of associates.

In an embodiment of the invention, there may be an associate module. The associate module may include associates; an associate accounts module functionally linked to the associates and configured to manage associate accounts relating to each associate; and/or storage modules functionally linked to the associate accounts and configured to store data relating to each associate account.

In another embodiment there may be a cascading data entry module functionally linked to the event module and configured to prompt for data associated with a primary event.

In still another embodiment an event module and an item module may be linked by foreign keys in item and event data records.

In still yet another embodiment there may be a method to account for the financial state of an entity. The method may include managing a collection of items with an item module; describing and managing financial events of an entity with an event module; entering item data of the entity into the item module; and/or entering transaction data of the entity into the event module.

There may be included within the method one or more steps of asserting a master structure over the item module and event module with a general ledger module. Also, there may be included, one or more steps of organizing transaction data according to a rule set into a set of accounts within the general ledger wherein the set of accounts included in the general ledger module are configured to fit within standard accounting categories.

Also, there may be included, one or more steps of establishing a plurality of item collections configured to organize types of items; describing and maintaining a record for each individual member of the corresponding item collection; and/or summarizing values and interactions between items and between items and events.

Additionally, there may be included one or more steps of facilitating transaction posting with an event table; summarizing the values of each event/item record from the event table; and/or storing a record for each transaction.

More, there may be included one or more steps of managing a collection of associates with an associate module linked to another module selected from the group consisting of general ledger module, event module and item module. Still more, there may be included, one or more steps of identifying associates involved in transactions with the entity and creating a record for each associate; and/or managing, separately from items, associate accounts relating to each associate.

In another embodiment there may be included one or more steps of prompting a user for data associated with a primary event with a cascading data entry form. Also, there may be included, one or more steps of linking the general ledger module, the event module, the associate module and the item module with foreign keys in item and event data records. More, there may be included, one or more steps of re-configuring the rule set.

In still another embodiment, there may be an accounting system including a general ledger module; an account defined within the general ledger; an event list module linked to the account; an item table module linked to the account; an event transactions module linked to the event list module; an event type results module linked to the event list module and the event transactions module; an associates master ID module; an associates locations module linked to the associate master ID module; an associate accounts module linked to the associates locations module and the general ledger module; an item/event template and results module linked to the item table module, the event list module, and the event transaction module; a dynamic data entry module linked to the account module and the item/event template module; a table key for each item, event, transaction, associate, associate location, table and account; and/or a user interface with access to a module selected from the group consisting of: the dynamic data entry module, the account module, the item/event templates module and the event type results module, wherein access to a first element selected from the group consisting of: item, event, transaction, associate, associate location, table and account, allows access to a second element selected from the group consisting of: item, event, transaction, associate, associate location, table and account, through the foreign key of the first element wherein the foreign key of the first element corresponds to the table key of the second element.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order for the advantages of the invention to be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1a illustrates a prior art conventional accounting system.

FIG. 1b illustrates a prior art Balance Sheet with Subledger, Detail Level 2;

FIG. 1c illustrates a prior art Entries by Account Table;

FIG. 2a is a block diagram of the item and event systems according to one embodiment of the invention;

FIG. 2b is a block diagram of a general ledger included in an accounting system according to one embodiment of the invention;

FIG. 2c is a block diagram showing details of a financial system according to one embodiment of the invention;

FIG. 3a is a block diagram showing an accounting system according to one embodiment of the invention;

FIG. 3b is a block diagram showing details of an associate system according to one embodiment of the invention;

FIG. 3c is a block diagram showing example interactions between the financial system and the associate system according to one embodiment of the invention;

FIG. 4 is a block diagram of an accounting system according to one embodiment of the invention;

FIG. 5 is a block diagram of the associate data structure according to one embodiment of the invention;

FIG. 6 is a block diagram of the associate data structure showing data field detail according to one embodiment of the invention;

FIG. 7 is an example of use of table keys and foreign keys according to one embodiment of the invention;

FIG. 8 is an example Item Table according to one embodiment of the invention;

FIG. 9 is an example Item/Event Results Table according to one embodiment of the invention;

FIG. 10 illustrates a Balance Sheet with Subledger, Detail Level 3, according to one embodiment;

FIG. 11 illustrates a Balance Sheet with Subledger, Detail Level 4, according to one embodiment;

FIG. 12 shows an example Balance Sheet with Subledger Item Screen according to one embodiment of the invention;

FIG. 13 shows an example of cascading data entry according to one embodiment of the invention.

FIG. 14 shows a transaction table together with other connected tables according to one embodiment of the invention.

FIG. 15 shows an expanded event table with summary amounts according to one embodiment of the invention.

### DETAILED DESCRIPTION OF THE INVENTION

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

Reference throughout this specification to “one embodiment,” “an embodiment,” or similar language means that a particular feature, structure, or characteristic described in connection with the embodiment is included in at least one embodiment of the present invention. Thus, appearances of the phrases “one embodiment,” “an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

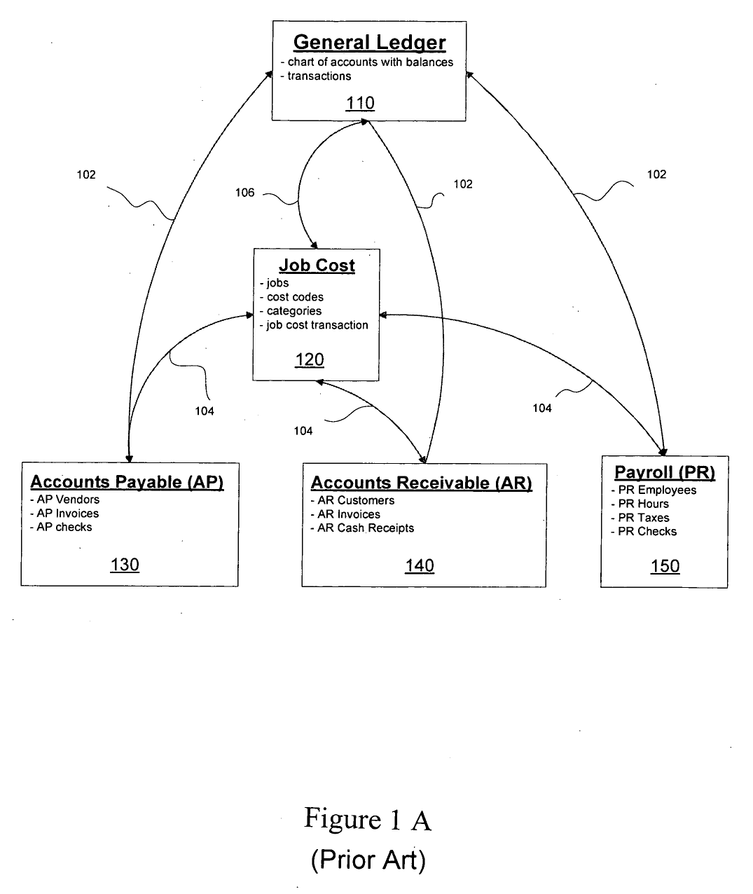

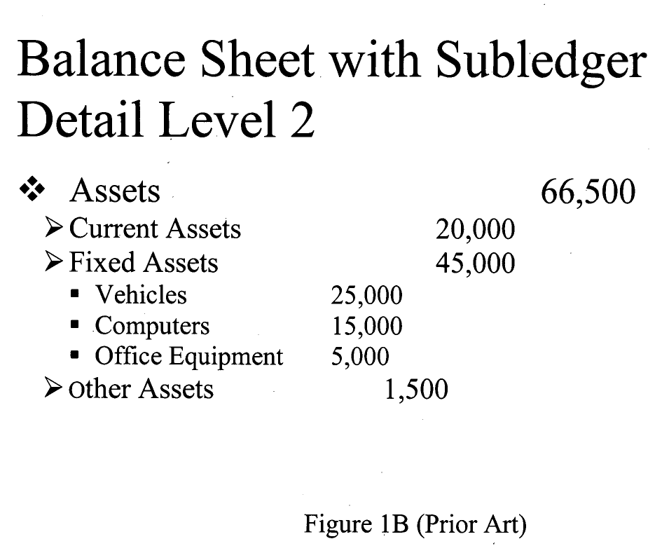

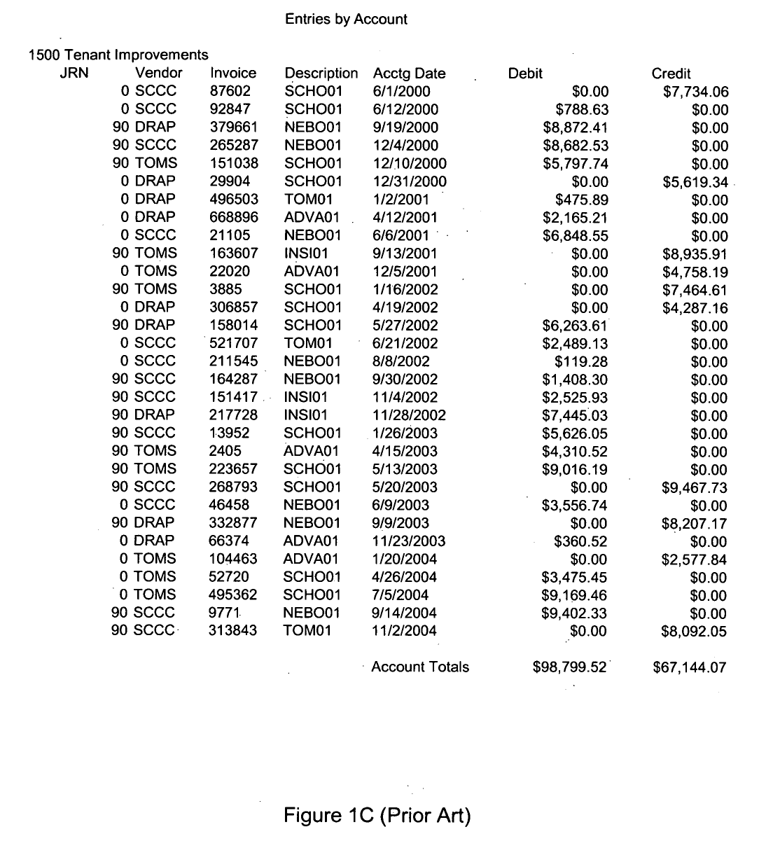

FIG. 1a illustrates a prior art conventional accounting system. The accounting system has a general ledger module 110, a job cost module 120, an accounts payable module 130, an accounts receivable module 140 and a payroll module 150. Through links 102, the accounts payable module 130, the accounts receivable module 140 and the payroll module are coupled to the general ledger module 110. Through links 104, the accounts payable module 130, the accounts receivable module 140 and the payroll module are coupled to the job costs module 120. Additionally, the job cost module 120 is connected to the general ledger module through link 106. The modules 110, 120, 130, 140 and 150 may share information through each of the links 102, 104 and 106. Notably missing are any links allowing, for example, the accounts payable module 130 to directly share information with the accounts receivable module 140. It is notable that while the non-general ledger accounting modules 130, 140 and 150 are represented by accounts in the general ledger, not all accounts represented in the general ledger 110 have accounting modules. Further, while the diagram shows a link between the general ledger module 110 and each of the other accounting modules 130, 140 and 150, this link is not always present and if present may be as tenuous as merely manually matching amount totals by visual inspection to verify accuracy.

FIG. 1b illustrates a prior art Balance Sheet with Subledger, Detail Level 2. This is an example of the detail level available in the prior art.

FIG. 1c illustrates a prior art Entries by Account report. This demonstrates the level of detail provided in the prior art when more detail than that provided in FIG. 1b is required. While FIG. 1c entails only a single page, it is common in the prior art for an Entries by Account report to extend for hundreds of pages or more.

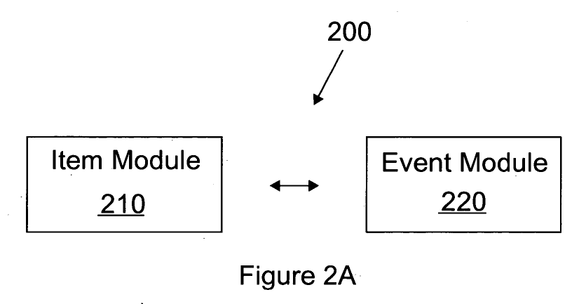

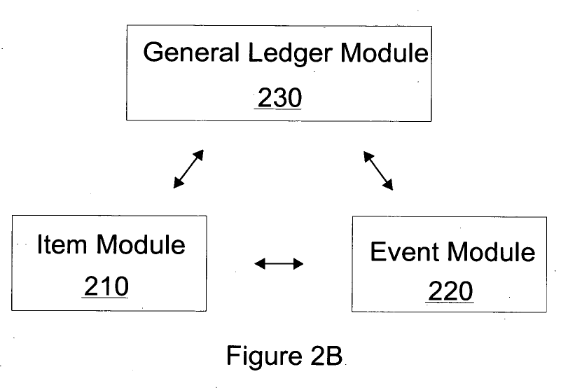

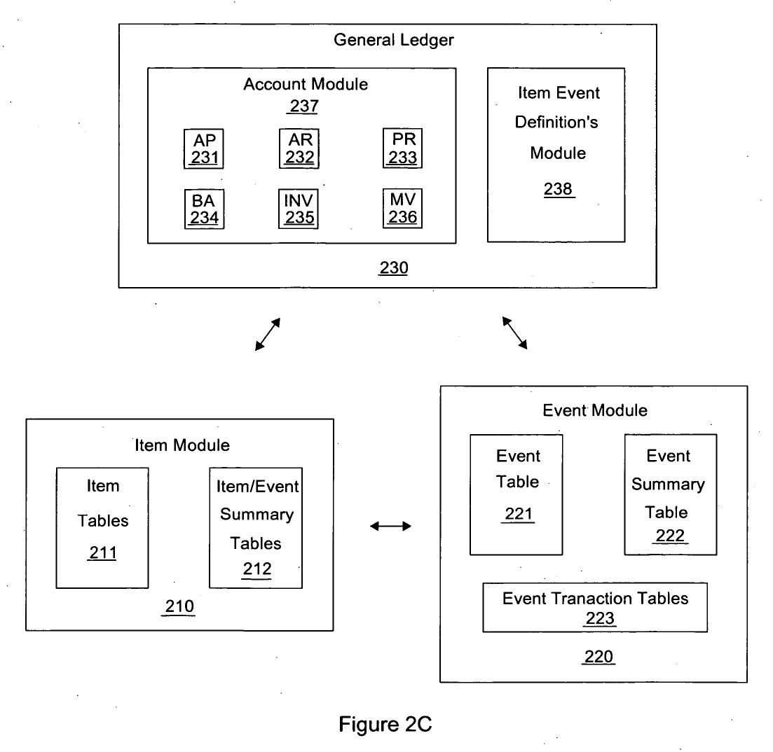

FIG. 2a is a block diagram of the item and event modules according to one embodiment of the invention. Accounting system 200 comprises an item module 210 and an event module 220. Item module 210 and event module 220 are interlinked. The interlinking may include data sharing, data linking, and/or data managing. The linking is founded on the principle that every accounting transaction is a combination of at least one event and at least one item. Further, evaluation of each transaction is based on the particular combinations of items and events. In this embodiment, the data records themselves are functional records keyed to provide the links between the various modules. Instead of channeling the data through to tables, the data is given links and permissions to generate tables and otherwise display relations. The item module 210 is designed to manage the collection of items included in the accounting system 200. The event module 220 is designed to describe and manage the financial events of an entity.

The accounting system 200 may also be a general ledger wherein entries in the general ledger must be at least an item or an event. Not all items and events are financial statement elements, or accounts. Financial transaction data is entered into accounts.

FIG. 2b is a block diagram of a general ledger included in an accounting system according to one embodiment of the invention. Here, the accounting system 200 includes a general ledger module 230, an item module 210 and an event module 220. The three modules are all linked, with the general ledger module 230 providing a master structure for the item module 210 and the event module 220.

The item module 210 is designed to manage the collection of items defined on the general ledger module 230 under the balance sheet as well as off balance sheet items such as contracts. The event module 220 is designed to describe the financial events of an entity. The general ledger module 230 is designed to integrate item data and event data, recording and summarizing the interaction between items and events. The general ledger module 230 may expand to include all standard accounts and account types as well as elements that do not appear on the financial statements and are not assigned account numbers. Examples of these elements include: contracts, accounts payable invoices, accounts receivable invoices, checks and bank statements.

FIG. 2c is a block diagram showing details of a financial system according to one embodiment of the invention. The general ledger module includes a set of accounts 237 and an item/event definitions module, or account definitions module 238. The accounts are organized under standard accounting categories (not shown). The categories include: Assets, Liabilities, Equity, Revenues, and Costs (or Expenses). The accounting system 200 uses the common properties of the categories to build on and expand the basic model. The general ledger module 230 is expandable and can be customized to work for any entity because general ledger accounts 237 can be added to the accounting system 200 as long as they are associated with one of the categories.

The accounts illustrated include Accounts Payable, or AP, 231, Accounts Receivable, or AR, 232, Payroll, or PR, 233, Bank Accounts, or BA, 234, Inventory, or Inv, 235, and Vehicles 236. These accounts 237 are each assigned transactions by the general ledger module 230 with the assistance of the item/event definitions module 238 and based on conditions including event/item types, specific item selection, event and item modifiers, and transaction values. In the illustrated embodiment, the conditions are defined in the item/event definitions module and are configurable and intended to be configured for the entity by a qualified accountant. The general ledger module 230 is the hub of the accounting system wherein the general ledger 230 is the destination of all financial transactions and the source of financial statements. The structure of accounts 237 within the general ledger 230 ensures balanced entries through the double entry system and therefore provides a balanced, general financial overview of an entity.

The item module 210 includes item tables 211 and item/event summary tables 212. Each item collection originates on the general ledger module 230. Each unique item collection is mapped to an item table 211 which describes and maintains a record for each individual member of its collection. The values of all members in an item collection sum to the account balance on the general ledger module 230.

There is no limit to the number of item tables 211 in the accounting system 200. Each item originates on the general ledger module 230. For each new item record added to the general ledger 230, the accounting system either maps to an existing item table 211 or creates a new item table 211 for the record.

Each item table 211 has an item/event summary table, or child table 212, that records summarized values and interactions between items and between items and events. In the item/event summary tables 212, interactions and values are summarized for each unique combination of key records including account numbers and modifier fields. Modifier fields are descriptive fields describing features such as color, make, model and year produced, if for example a vehicle record were to have modifiers. Entities may need to distinguish and/or group items and/or events. The modifier system in this embodiment is designed to standardize this by making lists of possible selections available to both items and events. The modifier fields are added to the item tables 211 and values are assigned as items are recorded or as they change status. Balances on the item/event summary tables 212 are maintained by accounting period.

The event module 220 is designed to describe and manage the financial events of an entity. The event module 220 includes an event table 221, an event summary table 222, and event transaction tables 223. Each event originates on the general ledger module 230. For each general ledger event, an event is created on the event table 221 and on the event summary table 222 for that event and an event transaction table 223 is created.

The event table 221 is used for transaction posting, instead of using the accounts list as in the old model. Events alone are insufficient to fully describe transactions, so item types from the general ledger module 230 are combined with and nested under the events on the event table 221. These combinations create new records on the event table 221 and are the basis for transaction posting.

The event summary table 222 summarizes the values of each event/item record form the event table 221. The event summary table 222 summarizes by unique combinations of key records including event/item records, account numbers and event modifiers. Balances in the event summary table 222 are maintained by accounting period.

The event transactions tables 223 contain a record for each transaction and are designed to uniquely describe each different event in a transaction. The event transactions tables 223 contain all the fields used to uniquely describe the transaction including account number and event modifiers assigned to each transaction. Modifier fields are added to the event transaction tables 223. The fields are made available on the transaction entry forms and values are assigned as the transactions are recorded.

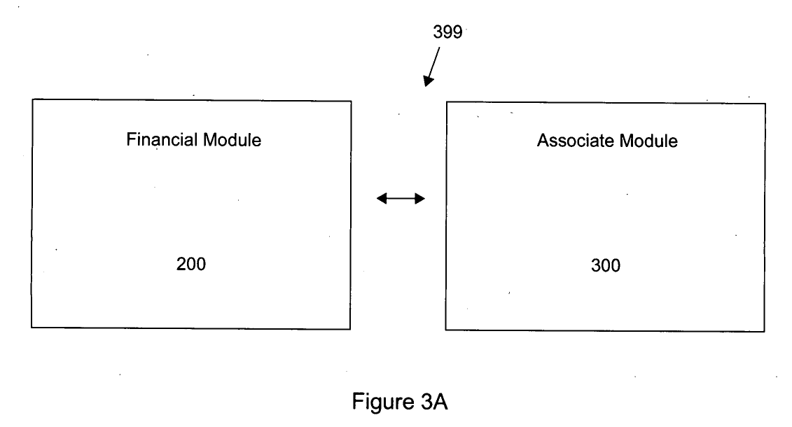

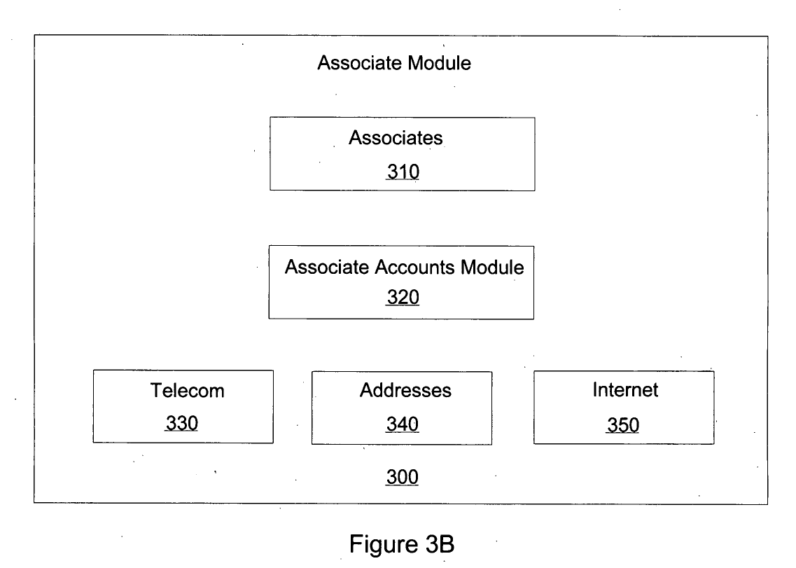

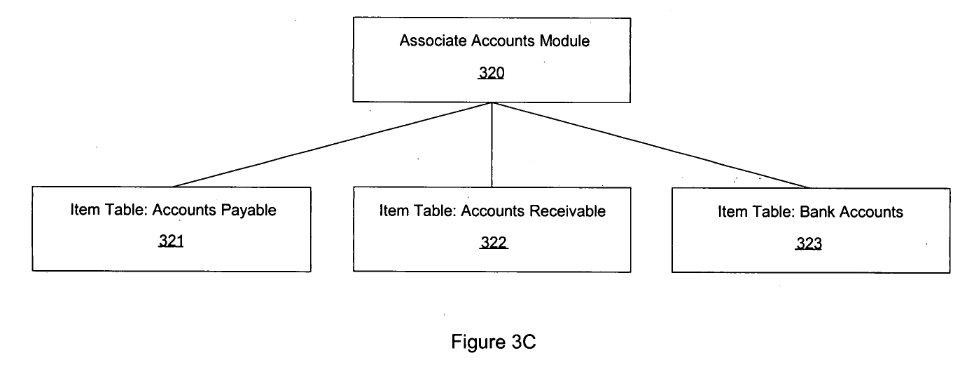

FIG. 3a is a block diagram showing an accounting system according to one embodiment of the invention. The accounting system 399 includes a financial module 299 and an associate module 300. The financial module 299 is designed to manage the financial data of an entity. A financial module 299 may be similar in structure to the accounting system 200 (See FIG. 2a). However, in the embodiment illustrated in FIG. 3a, the financial module does not treat associates identically to items. The associate module 300 is configured to interact with the financial module 299 but also configured to configurably restrict certain interactions between the financial system 299 and the associate module 300. The associate module 300 is configured to manage the collection of associates.

FIG. 3b is a block diagram showing details of an associate system according to one embodiment of the invention. The associate module illustrated includes associates 310, an associate accounts module 320, a telecom module 330, an address module 340 and an internet module 350. Associates 310 are entities involved in transactions with the business entity using the accounting system 399. While associates 310 may be treated as items in accounting system 200 (See FIG. 2a), the embodiment illustrated contemplates a form of treatment of associates separate from all other items. Associates 310 are subject to government regulations of degrees and kinds often very different from other items. Subsequently, data storage and management as it relates to associates 310 are subject to special requirements which may be better met by a module designed to manage the collections of associates 300.

The associate accounts module 320 is configured to manage associate accounts relating to each associate 310. For example, an associate 310 may have more than one physical location, more than one business organization or may be both a supplier and consumer. The associate accounts module 320 is a hub in the associate module. The telecom module 330, addresses module 340 and internet module 350 are illustrated as examples of modules relating to each associate account.

FIG. 3c is a block diagram showing example interactions between the financial module 299 (See FIG. 3a) and the associate module 300 (See FIG. 3b) according to one embodiment of the invention. The associate accounts module 320 is illustrated in this embodiment to also be a hub for interaction between the associate module 300 and the financial module 299. Three links, or interactions 321, 322 and 323, are illustrated. The item table: accounts payable link 321 would be used in the case of an associate 310 or an associate account who is a vendor for the entity using the accounting system 399. The item table: accounts receivable link 322 would be used in the case of an associate 310 or an associate account who is a customer of the entity using the accounting system 399. The item table: bank accounts link 323 would be used in the case of a n associate 310 or associate account who is a bank for the entity using the accounting system 399. These links may be to different associates 310 or different associate accounts or may be for the same associate 310 or associate account or for the same associate 310 but different associate accounts.

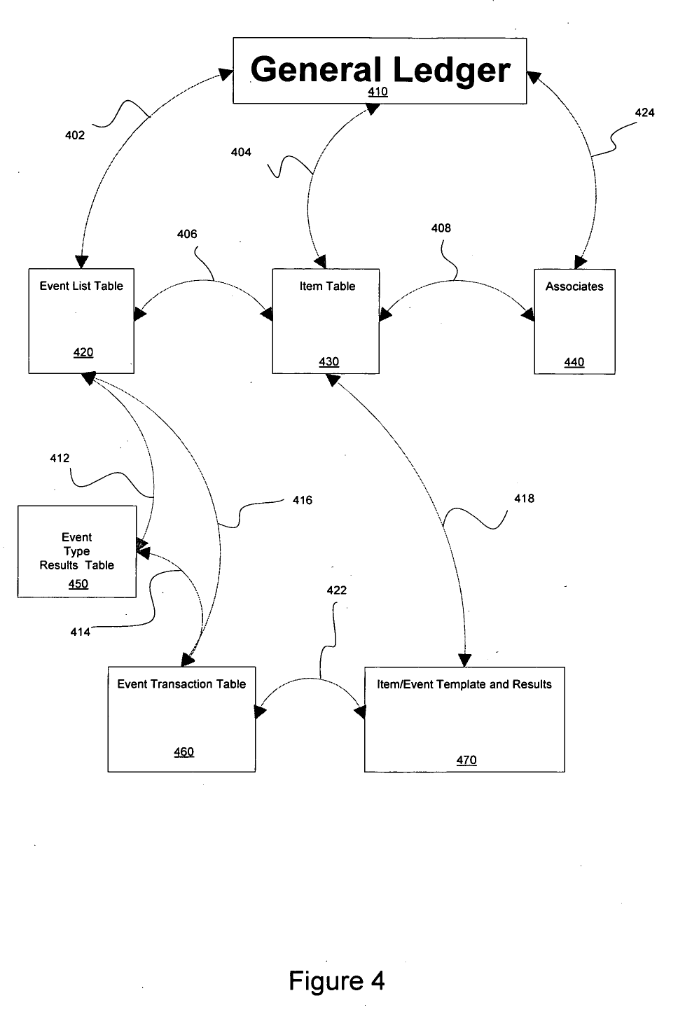

FIG. 4 is a block diagram of an accounting system according to one embodiment of the invention. There is a general ledger module 410 linked by link 402 to the event list table module 420, by link 404 to the item table module and by link 424 to the associate module 440. Further the item table module 430 is linked by link 406 to the event list table module 420, by link 408 to the associate locations table module 440 and by link 418 to the item/event template and results module 470. The item/event template and results module is linked by link 422 to the event transaction table module 460. The event transaction table module 460 is linked by link 416 to the event list table module 420 and by link 414 to the event type results table 450. The event type results table 450 is linked by link 412 to the event list table module 420.

As can be seen, there is significant direct linkage among the non-general ledger modules. These links allow the accounting system to access information across the modules, without first requiring access to the general ledger module. For example, information may be accessed in the event transaction table module 460 from the item/event template and results table module 470 through link 422 without first requiring access from the event transaction table module 460 to the general ledger module 410.

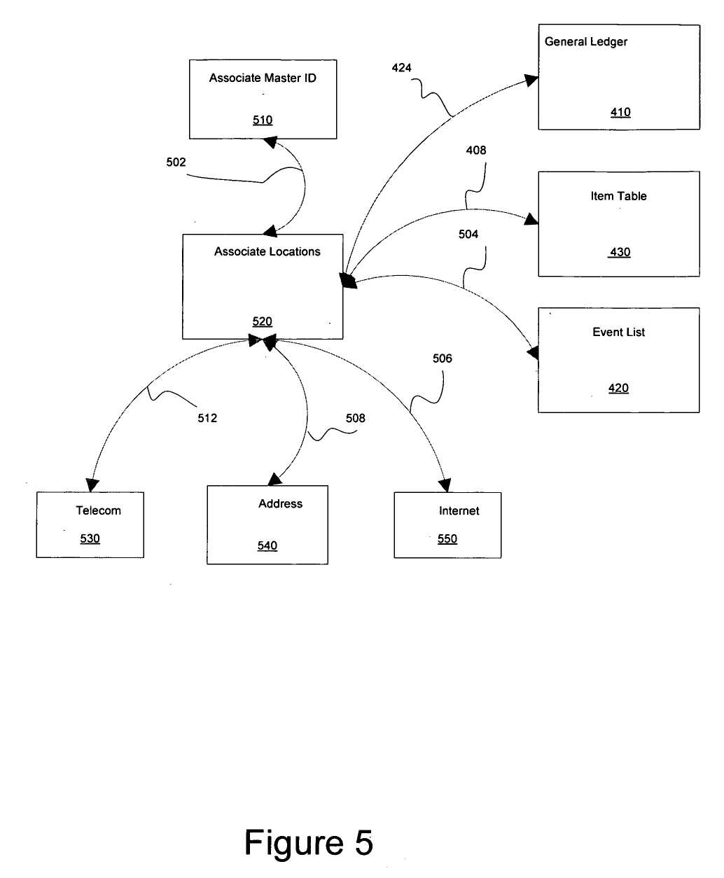

FIG. 5 is a block diagram of the associate data structure according to one embodiment of the invention. The associate data structure comprises the associate master id module 510, the associate locations module 520, the telecom module 530, the address module 540 and the internet module 550. The general ledger module 410, the item table module 430 and the event list module 420 are also shown.

The associate master id module 510 is linked to the associate locations module 520. It is noted there may be a plurality of associate locations assigned to a single associate master id. For example, a single associate may have multiple geographical locations. The associate locations module 520 is connected by link 512 to the telecom module 530, wherein telecom data may be stored about the particular associate location. The associate locations module 520 is connected by link 508 to the address module 540, wherein address data may be stored about the particular associate location. The associate locations module 520 is connected by link 506 to the internet module 550, wherein internet data may be stored about the particular associate location. It is noted that a single associate locations module 520 may be connected to a plurality of telecom modules 530, address modules 540 and internet modules 550.

The associate locations module 520 in one embodiment is linked by link 424 to the general ledger module 410 and by link 408 to the item table module 430, as in FIG. 4. Further, the associate locations module 520 is linked by link 504 to the event list 420. It is noted that in this embodiment, the associate master id 510 is never linked directly to anything other than the associate locations module 520, which enhances the ability to tier access to associates and associate information in a way which enhances the security of such information.

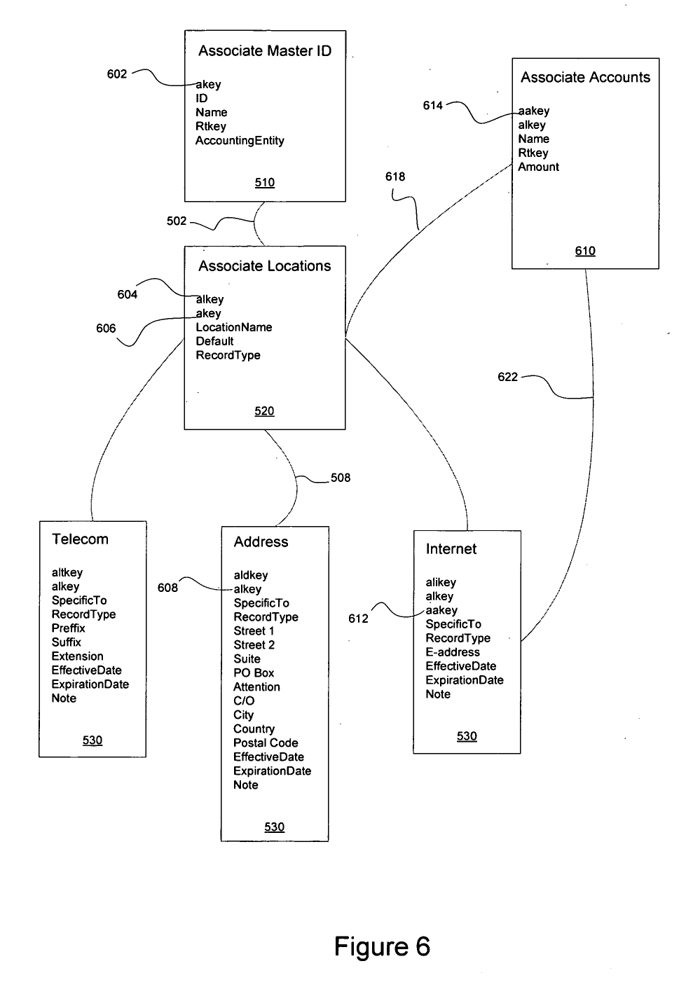

FIG. 6 is a block diagram of the associate data structure showing data field detail according to one embodiment of the invention. The associate master id module 510 has a table key labeled as “akey” 602 in the drawing. The associate locations module 520 has a table key labeled “alkey” 604 in the drawing. Further, the associate locations module includes a foreign key labeled “akey” 606 corresponding to the table key labeled “akey” 602. The foreign key “akey” 606 provides the portion of the link 502 wherein access to the associate master id module 510 may be provided from the associate locations module 520. This example shows how a foreign key may provide access to a more general data set from a more specific set within the same module. This is further exemplified by the foreign key “alkey” 608 of the address module 530, which may be used to refer in a similar way from the address module 530 to the associate locations module 520.

Additionally, in this embodiment, there is an associate accounts module 610 for summarizing the associate locations into the general ledger 410. The associate accounts module 610 is linked to the general ledger module 410 (not shown). There is a link 618 connecting the associate locations 520 to the associate accounts 610. Further, in this embodiment, the internet module 530 has a foreign key “aakey” 612 corresponding to the table key “aakey” 614 of the associate accounts module 610, wherein reference may be made to the associate accounts module 610 from the internet module 530. This may occur, for example, where an associate is doing business in more than one channel with the user of the accounting system. For example, where an associate supplier having an internet address used to communicate with the user of the accounting system may also rent that same internet address from the user of the accounting system. The foreign key would then allow access to the associate account module holding the account information for the rented internet address from the internet contact information module of the associate.

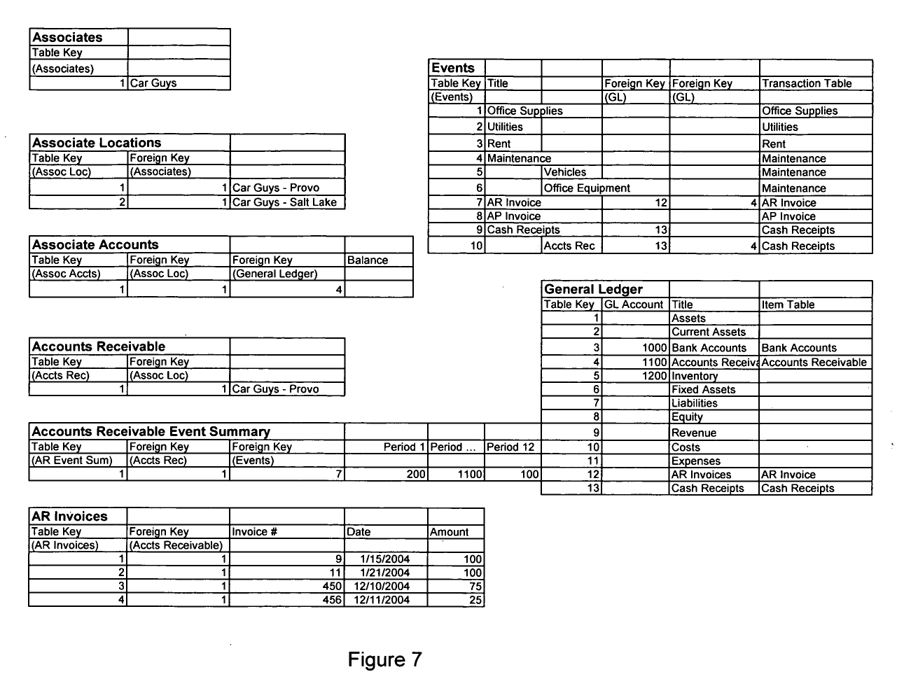

FIG. 7 is an example of use of table keys and foreign keys according to one embodiment of the invention. The figure shows tables having records, wherein the records are composed of fields. In this example, each record has a table key field. Further, various foreign key fields link information from a record on one table to a record on another. Still further, a record may have more than one foreign key field, as in the case of the records in the Accounts Receivable Table and the Events Table.

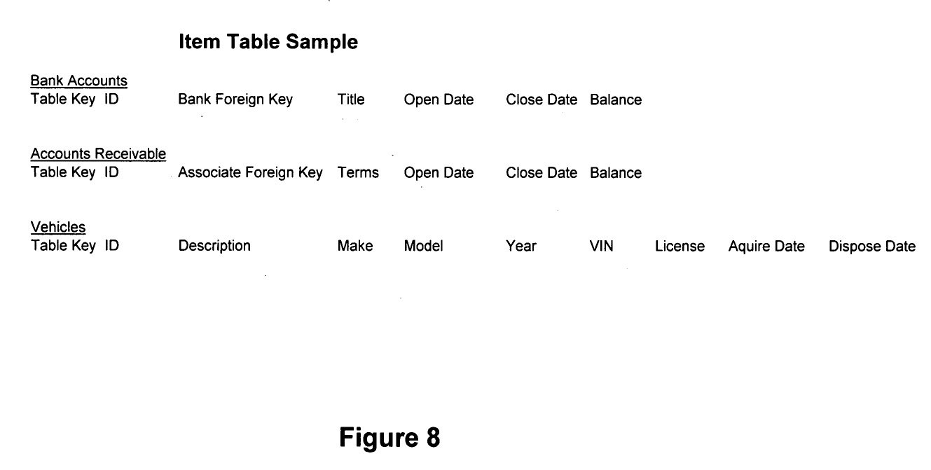

FIG. 8 is an example Item Table according to one embodiment of the invention, showing the table key fields of each item type as well as example foreign key fields.

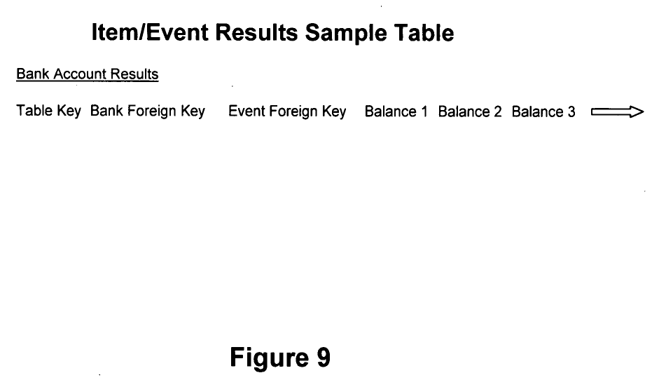

FIG. 9 is an example Item/Event Results Table according to one embodiment of the invention, showing example fields for the example item/event of Bank Account Results, including the table key field and two example foreign key fields.

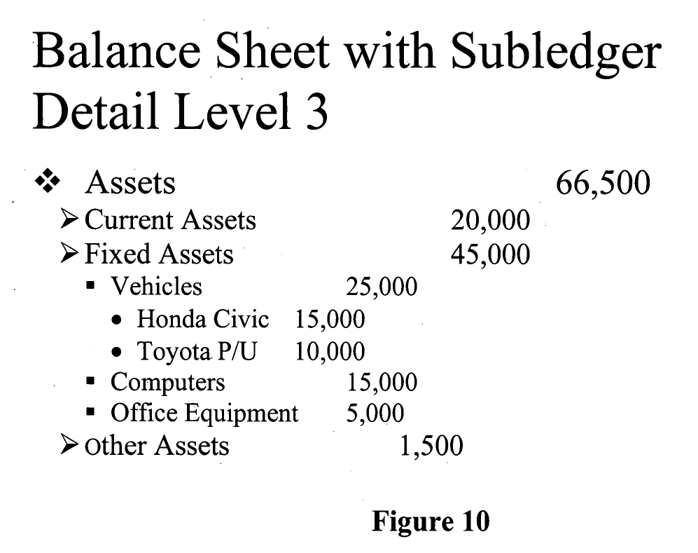

FIG. 10 illustrates a Balance Sheet with Subledger, Detail Level 3, according to one embodiment, showing additional detail available because of the access provided by the foreign keys of one embodiment of the invention.

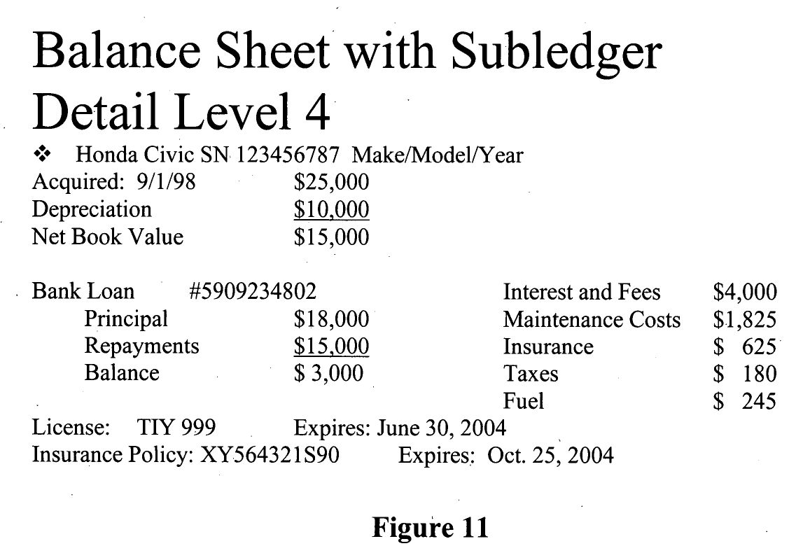

FIG. 11 illustrates a Balance Sheet with Subledger, Detail Level 4, according to one embodiment, showing additional detail available because of the access provided by the foreign keys of one embodiment of the invention.

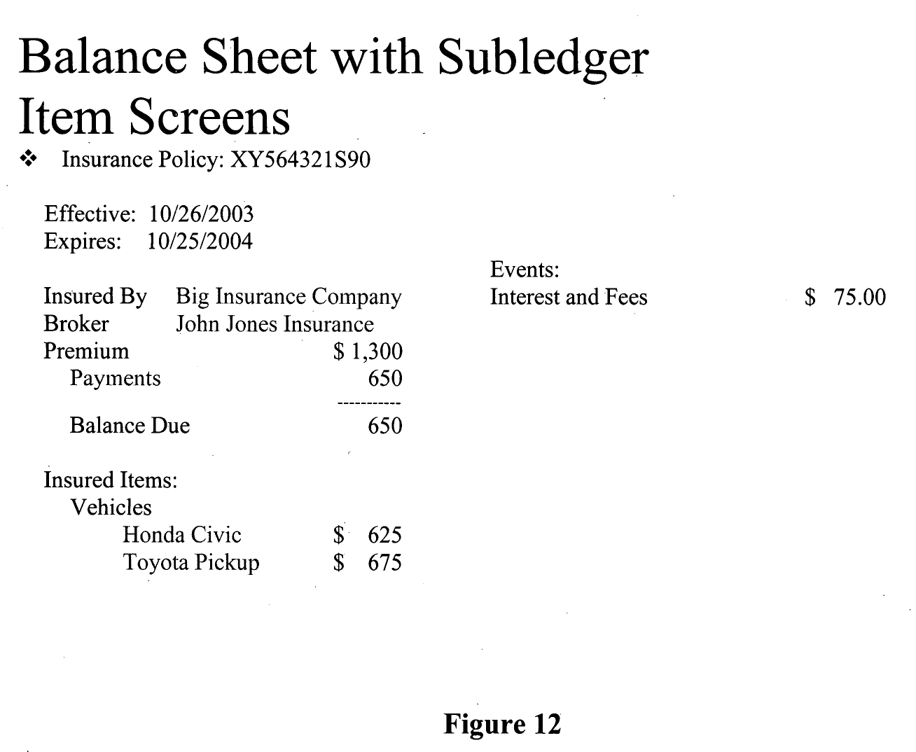

FIG. 12 shows an example Balance Sheet with Subledger Item Screen, detailing the insurance policy included in FIG. 11. In one embodiment of the invention, FIG. 12 could be immediately displayed because of a direct link from a foreign key in FIG. 11 linking the information in FIG. 11 to the insurance record in the Item Table module.

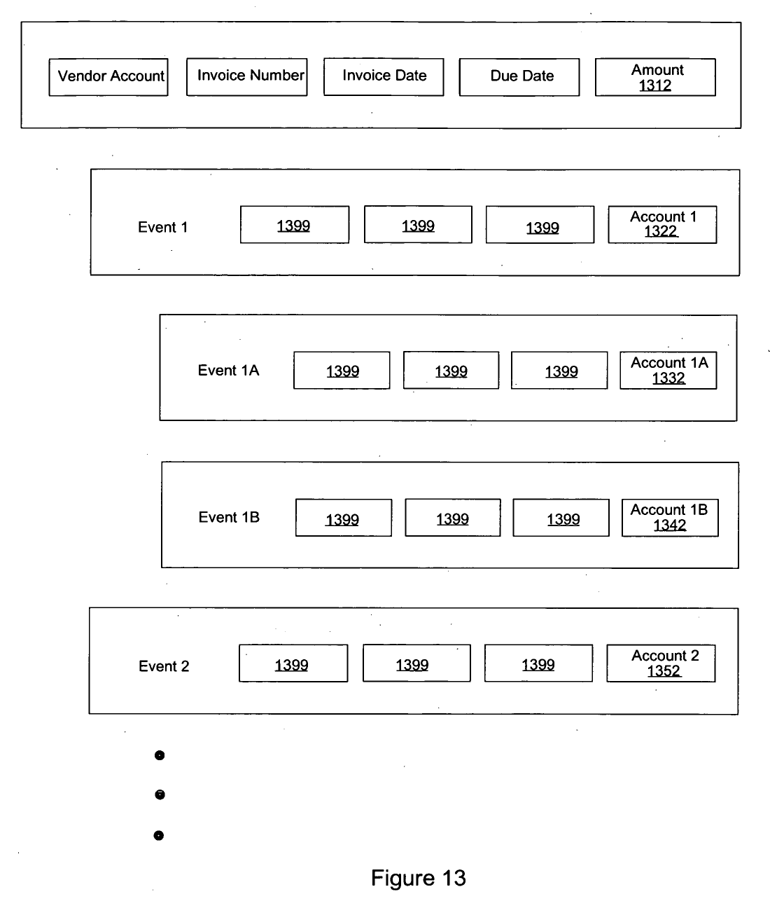

FIG. 13 shows an example of cascading data entry, or dynamic data entry 1300, according to one embodiment of the invention. There is a master record 1310 having entered data including a total amount 1312. Also shown is a first event entry line 1320 having various dynamic data entry fields 1399 determined by the previously entered data and a first amount 1322 which would be summed into the total amount 1312. Further shown are a first-a event line 1330 and a first-b event line 1340 each having various dynamic data entry fields 1399 determined by the previously entered data and a first-a amount 1332 and first-b amount 1342 each summed into the first amount 1322. Further there is a second event line 1350 having a dynamic data entry field 1399 determined by previously entered data and a second amount 1352 summed into the total amount 1312. Additional event lines or sub-event lines may generate as data is entered, as well, the dynamic fields 1399 may change, appear, or disappear as data is entered.

In operation, a data entry user may enter business information, such as financial transaction data, through dynamic data entry 1300. As details are entered into the dynamic data entry, various additional fields may become available according to a data entry rule set that may have been previously configured. The entered data may then be processed immediately or at some other, later, time either by the same data entry personal, or preferably by a more highly trained person and/or a rule set that may or may not be related to the data entry rule set. In this way the data entry is different from financial accounting as they may be done in different steps and may also be done by different personal and/or processes. For example, there may be a large set of data entry personal entering business data, which may then be processed by a computer according to a rule set. The processing may post the business data to accounts and/or in other ways relate the data to the accounting system. The rule set may be embodied in any way, including but not limited to computer code, knowledge in one skilled in the art, or displayed. The rule set may be configurable to accommodate changes such as changes in business, business environments, accounting theory, account definition, and/or any other changes as would be understood by one skilled in the art.

A purpose of the dynamic data entry, or cascading data entry 1300 may include linking related items and/or events, especially for complex items such as complicated insurance policies. For example, where an insurance policy on a fleet is increased to cover a vehicle new to the accounting system, there may be old items and/or events and new items and/or events and the dynamic data entry 1300 may be configured to prompt or allow a data entry user to properly enter the linked information such that substantially complete information relating to the insurance policy for the fleet and any changes thereto may be properly entered into the system. The accounting system may be configured to track relationships among and between complex items and items included therein.

Data entry forms may be dynamic, such that the fields on the form may appear or be activated in response to entries in other form fields. Different event/item combinations may require different fields to identify the specific items and also to adequately describe a transaction. Further, the dynamic data entry 1300 may also place restrictions on the data entry user such that mistakes may be reduced. For example, only those options that make sense to the accounting system may be available to the data entry user, thereby reducing the likelihood that incomprehensible data be entered into the system.

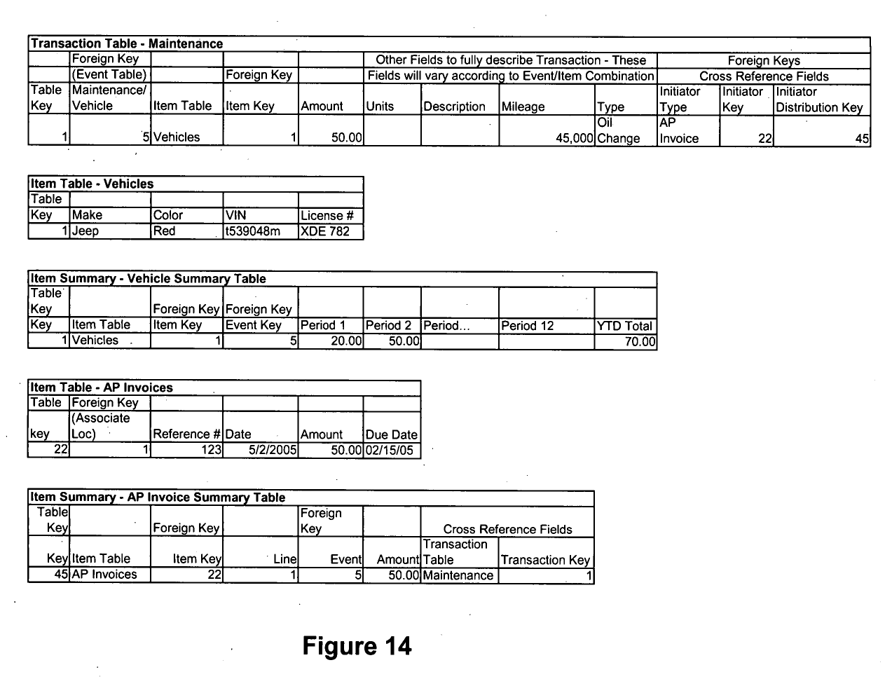

FIG. 14 shows a transaction table together with other linked tables according to one embodiment of the invention. In particular, there is a Transaction Table—Maintenance; an Item Table—Vehicles; an Item Summary—Vehicle Summary Table; an Item Table—AP Invoices; and an Item Summary—AP Invoices Summary Table. The Transaction Table—Maintenance is linked to the other tables by foreign keys. The Transaction Table—Maintenance contains foreign keys 1, 22, and 45. Foreign keys provide links to the table keys of the appropriate tables, as described by the table identifier entry associated with the foreign key.

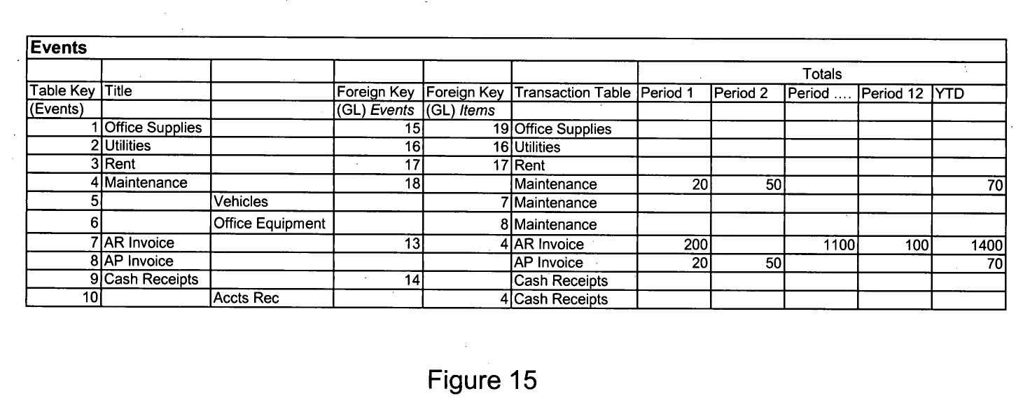

For example, the second (reading right to left) listed foreign key in the Transaction Table—Maintenance is foreign key 1 associated with the table Item Table—Vehicles. Therefore, a user having access to the Transaction Table—Maintenance may also access the information associated with table key 1 of the Item Table—Vehicles. The first foreign key (5) relates to the event table in FIG. 15.

Also, multiple foreign keys may be associated to a single type, describing a set of tables having similarities. One example of this is illustrated in foreign keys 22 and 45. 22 and 45 are both associated with the Initiator Type of AP Invoices. However, the association is further described such that foreign key 22 is associated with Item Table—AP Invoices and foreign key 45 is associated with Item Summary—AP Invoice Summary Table. One skilled in the art would appreciate that this is merely one example of a method of association. One skilled in the art would appreciate the numerous and varied modes of associating foreign keys to sets of information.

In operation, a user having access to the Transaction Table—Maintenance may, through foreign key 22, access the Invoice associated with a particular invoice relating to the maintenance event detailed in the Transaction Table—Maintenance. In the illustrated case, the information provided includes a Reference # of 123, a date of May 2, 2005 an amount of 50.00, and a due date of Feb. 15, 2005.

In addition, the illustration also includes foreign keys among tables other than the Transaction Table—Maintenance. For example, in the Item Summary—AP Invoice Summary Table there is included a foreign key, foreign key 22, linking the Item Summary—AP Invoice Summary Table to the Item Table—AP Invoices.

FIG. 15 illustrates an expanded event table with summary amounts according to one embodiment of the invention. The rows are characterized by a number in the Table Key (Events) column. In particular, number 5 in the Table Key (Events) column corresponds to the title Maintenance—Vehicle, referred to by FIG. 14. The columns contain summary information relating to each category, including totals for each period.

It is understood that the above-described preferred embodiments are only illustrative of the application of the principles of the present invention. The present invention may be embodied in other specific forms without departing from its spirit or essential characteristics. The described embodiment is to be considered in all respects only as illustrative and not restrictive. The scope of the invention is, therefore, indicated by the appended claim rather than by the foregoing description. All changes which come within the meaning and range of equivalency of the claims are to be embraced within their scope.

For example, although the modules are designated as all separate, it is also possible for some of the modules to be combined into a single module with multiplied functionality.

Moreover, it is envisioned that the modules may be configurable to meet the particular needs of the business using the accounting system. In particular, the accounts of the general ledger would be re-programmable and the tables could be re-configurable to accommodate different business types as well as future changes to the business.

It is envisioned that although significant description is given regarding using foreign keys to functionally link data records, the other methods known in the art of programming and database management would work as well.

Again, it is envisioned that the links provided by the key pairs may be one way or multiple way links.

Also, the links provided by the key pairs may be configured to only function for users with appropriate permissions.

Additionally, although the figures illustrate a specific set of modules, one skilled in the art would recognize that there are additional modules which may be added to the system and configured to use the invention.

It is also envisioned that not every module is necessary for every business, and that the invention may be practiced on a number of modules fewer than that presented in the drawings.

It is envisioned that the modules would not be limited to an accounting system in English or accounting in dollars.

Additionally, using a link provided by a key pair may also cause additional functionality, such as but not limited to taking a log of the key pair links followed by the user.

It is expected that there could be numerous variations of the design of this invention. An example is that the modules may be configured to organize the data differently, especially across different types of businesses. Also, the illustrations provide examples of organization and structure and are not to be taken as limiting. For example, each table may include more entries, such as additional columns or rows that may include additional information, than those illustrated. Additionally, the various tables may be linked, for example by foreign keys, in limitless ways in conformance with the claims of the invention. Further, the associations may be configurable and adjustable to permit flexibility for various businesses and business models.

Further, although the figures used names and numbers as foreign keys and table keys, one skilled in the art would recognize that there are many ways to provide a link to another record or table as claimed, including, but not limited to: physical linking, encrypted linking, linking by a unique identifier, linking by a set of identifiers, linking by a symbol, using a single identifier to link to multiple records and/or tables, using multiple links to link to the same record or table in different ways such as a link granting access full access to descriptors in a record or table and a limited link only granting access to certain descriptors and linking by a previous pattern of links.

Finally, it is envisioned that the modules of the system may be implemented on a variety of platforms. It is further envisioned that the modules of the system may not all be implemented on the same platform. It is still further envisioned that the platforms may be a combination of hardware and software.

Thus, while the present invention has been fully described above with particularity and detail in connection with what is presently deemed to be the most practical and preferred embodiment of the invention, it will be apparent to those of ordinary skill in the art that numerous modifications, including, but not limited to, variations in size, materials, shape, form, function and manner of operation, assembly and use may be made, without departing from the principles and concepts of the invention as set forth in the claims.

What is claimed is:

1. An accounting system, comprising:
an item module configured to manage a collection of items;
an event module linked to the item module and configured to describe and manage financial events of an entity; and
a general ledger module configured to provide a master management structure for the item module and event module.

2. The accounting system of claim 1, further comprising a set of entries wherein each entry includes at least one component selected from the group consisting of items and events.

3. The accounting system of claim 2, further comprising:
a set of accounts included in the general ledger module and configured to fit within standard accounting categories; and
an account definitions module included in the general ledger and configured to assign transactions to individual accounts within the set of accounts according to a determined rule set.

4. The accounting system of claim 2, further comprising:
a plurality of item collections defined in the accounting system and configured to organize types of items;
an item table for and corresponding to each item collection included in the item module and configured to describe and maintain a record for each individual member of the corresponding item collection; and
an item/event summary table for and corresponding to each item table included in the item module and configured to summarize values and interactions between items and between items and events.

5. The accounting system of claim 2, further comprising:
an event table included in the event module and configured to facilitate transaction posting;
an event summary table included in the event module and configured to summarize the values of each event/item record from the event table; and
an event transactions table included in the event module and configured to contain a record for each transaction.

6. The accounting system of claim 2, further comprising an associate module restrictably linked to a module selected from the group consisting of general ledger module, item module, and event module and configured to manage a collection of associates.

7. The accounting system of claim 6, wherein the associate module comprises:
associates;
an associate accounts module functionally linked to the associates and configured to manage associate accounts relating to each associate; and
storage modules functionally linked to the associate accounts and configured to store data relating to each associate account.

8. The accounting system of claim 1 further comprising a cascading data entry module functionally linked to the event module and configured to prompt for data associated with a primary event.

9. The accounting system of claim 1 wherein the event module and the item module are linked by foreign keys in item and event data records.

10. A method to account for the financial state of an entity, comprising:
managing a collection of items with an item module;
describing and managing financial events of an entity with an event module;
entering item data of the entity into the item module;
entering transaction data of the entity into the event module; and
organizing the transaction data according to a rule set.

11. The method of claim 10, further comprising asserting a master structure over the item module and event module with a general ledger module.

12. The method of claim 11, further comprising organizing financial transaction data according to a rule set into a set of accounts within the general ledger wherein the set of accounts included in the general ledger module are configured to fit within standard accounting categories.

13. The method of claim 12, further comprising:
establishing a plurality of item collections configured to organize types of items;
describing and maintaining a record for each individual member of the corresponding item collection; and
summarizing values and interactions between items and between items and events.

14. The method of claim 13, further comprising:
facilitating transaction posting with an event table;
summarizing the values of each event/item record from the event table; and
storing a record for each transaction.

15. The method of claim 14, further comprising managing a collection of associates with an associate module linked to another module selected from the group consisting of general ledger module, event module and item module.

16. The method of claim 15, further comprising:
identifying associates involved in transactions with the entity and creating a record for each associate; and
managing, separately from items, associate accounts relating to each associate.

17. The method of claim 16, further comprising prompting a user for data associated with a primary event with a cascading data entry form.

18. The method of claim 17, further comprising linking the general ledger module, the event module, the associate module and the item module with foreign keys in item and event data records.

19. The method of claim 18, further comprising re-configuring the rule set.

20. An accounting system comprising:
a general ledger module;
an account defined within the general ledger;
an event list module linked to the account;
an item table module linked to the account;
an event transactions module linked to the event list module;
an event type results module linked to the event list module and the event transactions module;
an associates master ID module;
an associates locations module linked to the associate master ID module;
an associate accounts module linked to the associates locations module and the general ledger module;
an item/event template and results module linked to the item table module, the event list module, and the event transaction module;
a dynamic data entry module linked to the account module and the item/event template module;
a table key for each item, event, transaction, associate, associate location, table and account; and
a user interface with access to a module selected from the group consisting of: the dynamic data entry module, the account module, the item/event templates module and the event type results module, wherein access to a first element selected from the group consisting of: item, event, transaction, associate, associate location, table and account, allows access to a second element selected from the group consisting of: item, event, transaction, associate, associate location, table and account, through the foreign key of the first element wherein the foreign key of the first element corresponds to the table key of the second element.
